(19) United States
(12) Patent Application Publication
(10) Pub. No.: US 2026/0130746 A1
(43) Pub. Date: May 14, 2026

(54) ROTATING MECHANISM AND ELECTRIC TOOTHBRUSH

(71) Applicant: GUANGDONG XINBAO ELECTRICAL APPLIANCES HOLDINGS CO., LTD., Foshan (CN)

(72) Inventors: Jiangang GUO, Foshan (CN); Meng HUANG, Foshan (CN)

(21) Appl. No.: 19/445,748

(22) Filed: Jan. 12, 2026

Related U.S. Application Data
(63) Continuation of application No. PCT/CN2023/126896, filed on Oct. 26, 2023.

(30) Foreign Application Priority Data
Sep. 18, 2023 (CN) 202322542389.X

(51) Int. Cl. A61C 17/34; A46B 5/00; A46B 13/02

(52) U.S. Cl. CPC A61C 17/3418; A46B 5/0095; A46B 13/02

(57) ABSTRACT

The present disclosure provides a rotating mechanism and an electric toothbrush. The rotating mechanism is applied to the electric toothbrush, which includes a motor, an eccentric wheel arranged on an output shaft of the motor, and a drive shaft provided with a brush head. The rotating mechanism includes: a motor holder for mounting the motor; a swing rod, having a first end rotationally connected to the motor holder; and a connecting rod assembly, including a first connecting rod and a second connecting rod. When the eccentric wheel rotates, the swing rod is driven by means of the first connecting rod to swing with respect to the motor holder within a preset angle range, and when the swing rod swings, the drive shaft is driven by means of the second connecting rod to swing synchronously. The rotating mechanism has low assembly precision requirements and achieves stable and smooth transmission.

### CROSS-REFERENCE TO RELATED APPLICATIONS

This application is a continuation of International Application No. PCT/CN 2023/126896, filed on Oct. 26, 2023, which claims priority to Chinese Patent Application No. 202322542389.X, filed on Sep. 18, 2023, both of which are hereby incorporated by reference in their entireties.

### TECHNICAL FIELD

The present disclosure belongs to the technical field of electric toothbrushes, in particular to a rotating mechanism and an electric toothbrush.

### BACKGROUND

At present, most rotary toothbrushes on the market adopt an eccentric drive shaft. All the rotary toothbrushes on the market are driven by gears (such as a hybrid type vertical electric toothbrush provided by Chinese Patent Publication No. CN 110151351 A) or by a track groove (such as an electric toothbrush provided by Chinese Patent Authorization Publication No. CN 201223467Y).

A rotary toothbrush driven by gears defines an eccentric position generally by gear coupling, and the extremely high requirement for the clearance between gears cannot be satisfied by a common production process, leading to unstable quality of products. A rotary toothbrush driven by a track groove adopts an eccentric wheel to drive a track groove link, the track groove is in surface-to-surface contact with an eccentric wheel positioning shaft, and the large contact area between movable parts and a forced change of the motion direction result in irregular motions and deformation of the track groove.

### SUMMARY

In view of the above-mentioned technical problems in the prior art, the present disclosure provides a rotating mechanism and an electric toothbrush. The rotating mechanism has low assembly precision requirements and achieves stable and smooth transmission.

The embodiments of the present disclosure adopt the following technical solution:

A rotating mechanism is applied to an electric toothbrush. The electric toothbrush includes a motor, a drive shaft and an eccentric wheel arranged on an output shaft of the motor, and the drive shaft is connected to a brush head. The rotating mechanism includes:
a motor holder, used for mounting the motor;
a swing rod, having a first end rotationally connected to the motor holder; and
a connecting rod assembly, including a first connecting rod and a second connecting rod, the first connecting rod being rotationally connected to a wheel axle of the eccentric wheel and a second end of the swing rod, and the second connecting rod being rotationally connected to the drive shaft and the second end of the swing rod;
where, when the eccentric wheel rotates, the swing rod is driven by means of the first connecting rod to swing with respect to the motor holder within a preset angle range, and when the swing rod swings, the drive shaft is driven by means of the second connecting rod to swing synchronously.

Further, the rotating mechanism further includes an intermediate support, where the intermediate support is connected to the motor holder, a first positioning pillar and a second positioning pillar are arranged on the drive shaft, the first positioning pillar is rotationally connected to the intermediate support, and the second positioning pillar is rotationally connected to the second connecting rod.

Further, the first connecting rod, the swing rod and the second connecting rod are all located between the intermediate support and the motor holder and sequentially arranged along an axis of the output shaft of the motor.

Further, rotating shafts are arranged at the two ends of the swing rod respectively, shaft holes are formed in two ends of each of the two connecting rods respectively, the shaft holes in first ends of the two connecting rods are correspondingly disposed around the wheel axle of the eccentric wheel and the drive shaft, and the shaft holes in second ends of the two connecting rods are respectively disposed around the rotating shafts on the swing rod. In this way, the swing rod and the two connecting rods are easier to assemble.

Further, a connecting shaft parallel to an axis of the output shaft of the motor is arranged on the motor holder, the connecting shaft deviates from the output shaft of the motor, a positioning hole is formed in an end of the connecting shaft, and the first end of the swing rod extends into the positioning hole and is in clearance fit with the positioning hole. In this way, assembly of the swing rod is facilitated.

Further, the rotating mechanism further includes a top support and a sealing sleeve which are disposed around the drive shaft, where the top support is connected to the intermediate support, the sealing sleeve is fixed to the top support, the top support is in clearance fit with the drive shaft, and the sealing sleeve is in interference fit with the drive shaft. The sealing sleeve prevents a water flow from entering the electric toothbrush.

Further, the drive shaft is made from stainless steel, and the sealing sleeve is made from silicone.

Further, the drive shaft is sleeved with a rubber coating, such that the drive shaft is protected by the rubber coating.

Further, the present angle range is −20°˜20°.

An electric toothbrush includes the rotating mechanism according to any one of the above embodiments.

Compared with the prior art, the embodiments of the present disclosure fulfill the following beneficial effects:
Compared with a gear mechanism and a track type link mechanism, the rotating mechanism provided by the present disclosure connects the wheel axle of the eccentric wheel and the drive shaft by means of the two connecting rods and the swing rod, such that the drive shaft swings more stably and smoothly, and power consumption and noise are reduced, thus prolonging the service life of the electric toothbrush.

The following description provides additional aspects and advantages of the present disclosure, part of which will become obvious in the following description or be appreciated in practice of the present disclosure.

### BRIEF DESCRIPTION OF THE DRAWINGS

In the drawings that are not definitely drawn to scale, identical reference signs may describe similar components in different views, and identical reference signs with alphabetic suffixes or different alphabetic suffixes may indicate different examples of similar components. The drawings approximately illustrate various embodiments by way of examples rather than in a restrictive manner and are used to describe the embodiments of the present disclosure together with the specification and claims. In appropriate circumstances, reference signs in the drawings indicate identical or similar components. The embodiments are illustrative embodiments rather than exhaustive or exclusive embodiments of a device or method of the present disclosure.

FIG. 1 is an exploded view of a rotating mechanism according to one embodiment of the present disclosure.

FIG. 2 is a schematic structural diagram of the rotating mechanism in a case where an eccentric wheel does not rotate according to one embodiment of the present disclosure.

FIG. 3 is a schematic structural diagram of the rotating mechanism in a case where the eccentric wheel rotates anticlockwise by 90° according to one embodiment of the present disclosure.

FIG. 4 is a schematic structural diagram of the rotating mechanism in a case where the eccentric wheel rotates anticlockwise by 180° according to one embodiment of the present disclosure.

FIG. 5 is a schematic structural diagram of the rotating mechanism in a case where the eccentric wheel rotates anticlockwise by 270° according to one embodiment of the present disclosure.

FIG. 6 is a schematic structural diagram of an electric toothbrush according to one embodiment of the present disclosure.

FIG. 7 is a sectional view of the electric toothbrush according to one embodiment of the present disclosure.

FIG. 8 is an exploded view of the electric toothbrush according to one embodiment of the present disclosure.

In the FIGS.: 10, motor holder; 100, connecting shaft; 11, swing rod; 12, connecting rod assembly; 121, first connecting rod; 122, second connecting rod; 13, intermediate support; 14, top support; 15, sealing sleeve; 16, motor; 17, eccentric wheel; 170, wheel axle; 18, drive shaft; 181, first positioning pillar; 182, second positioning pillar; 19, control board; 20, housing; 21, rubber sleeve; 22, button.

### DESCRIPTION OF EMBODIMENTS

To allow those ordinarily skilled in the art to have a better understanding of the technical solution of the embodiments of the present disclosure, the present disclosure is described in further detail below in conjunction with accompanying drawings and specific embodiments.

One embodiment of the present disclosure provides a rotating mechanism, which is applied to an electric toothbrush. The electric toothbrush includes a motor 16, a drive shaft 18 and an eccentric wheel 17 arranged on an output shaft of the motor 16. The drive shaft 18 is connected to a brush head.

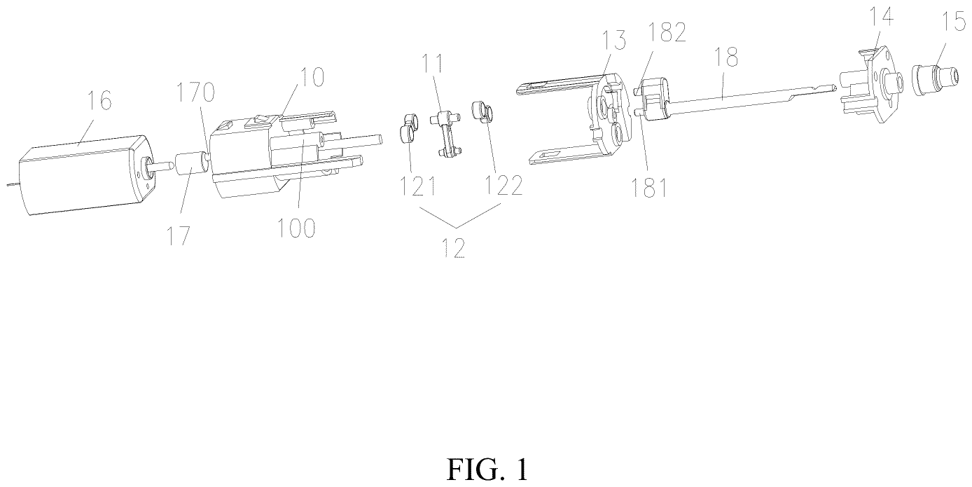

As shown in FIG. 1, in this embodiment, the rotating mechanism includes a motor holder 10, a swing rod 11 and a connecting rod assembly 12. The motor holder 10 is used for mounting the motor 16. A first end of the swing rod 11 is rotationally connected to the motor holder 10.

The connecting rod assembly 12 includes a first connecting rod 121 and a second connecting rod 122. The first connecting rod 121 is rotationally connected to a wheel axle 170 of the eccentric wheel 17 and a second end of the swing rod 11. The second connecting rod 122 is rotationally connected to the drive shaft 18 and a second end of the swing rod 11.

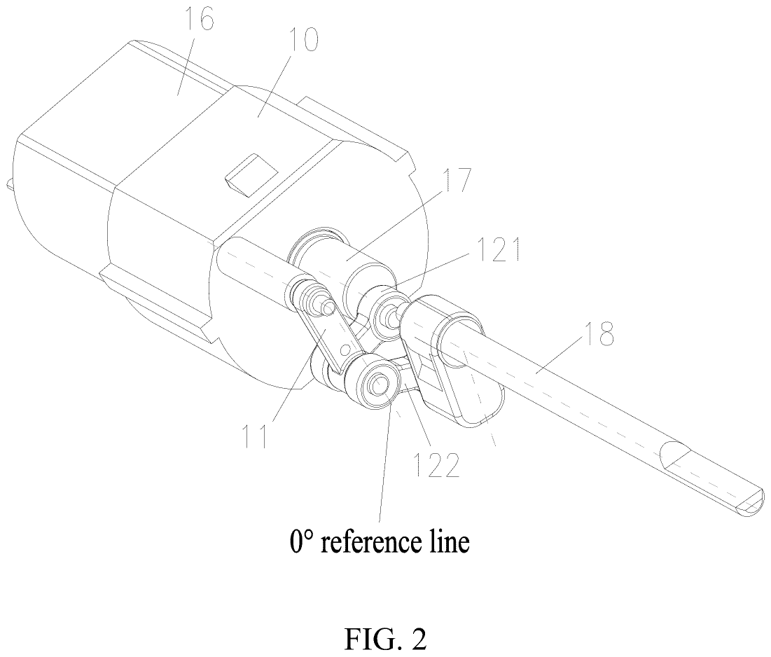

As shown in FIG. 2-5, in this embodiment, when the eccentric wheel 17 rotates, the swing rod 11 is driven by means of the first connecting rod 121 to swing with respect to the motor holder 10 within a preset angle range, such that when the swing rod 11 swings, the drive shaft 18 is driven by means of the second connecting rod 122 to swing synchronously with the swing rod 11. That is, it may be understood that a 360° rotational motion of the eccentric wheel 17 is converted into a synchronous swing motion of the swing rod 11 and the drive shaft 18. Because the drive shaft 18 is connected to the brush head, when the drive shaft 18 swings, the brush head will be driven to swing to brush teeth.

Preferably, in this embodiment, the preset angle range may be −20°˜20°.

Specifically, for example, in a case where the eccentric wheel 17 rotates anticlockwise and an initial position of the swing rod 11 is right located on a 0° reference line:

As shown in FIG. 2, when the eccentric wheel 17 does not rotate, the swing rod 11 is right located on the 0° reference line.

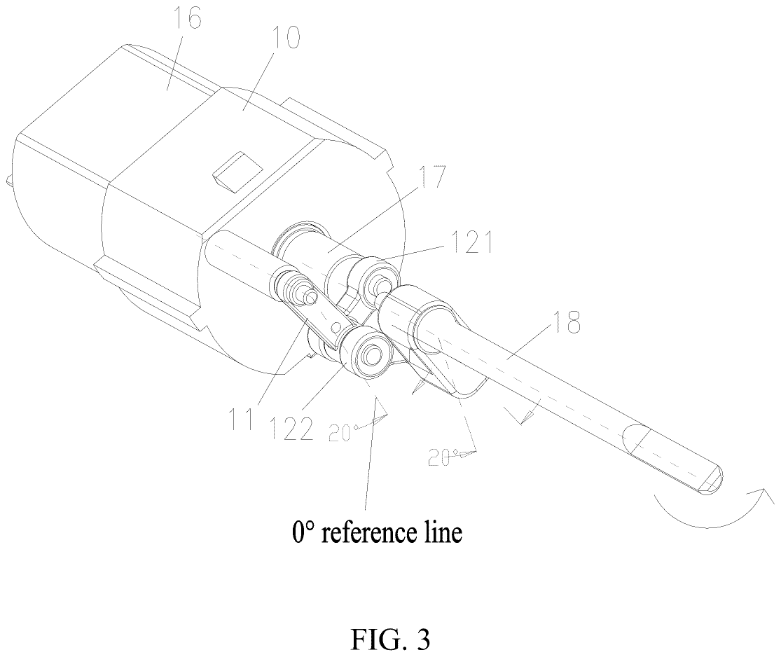

As shown in FIG. 3, when the eccentric wheel 17 rotates anticlockwise by 90°, the swing rod 11 is driven by means of the first connecting rod 121 to rotate anticlockwise by 20°.

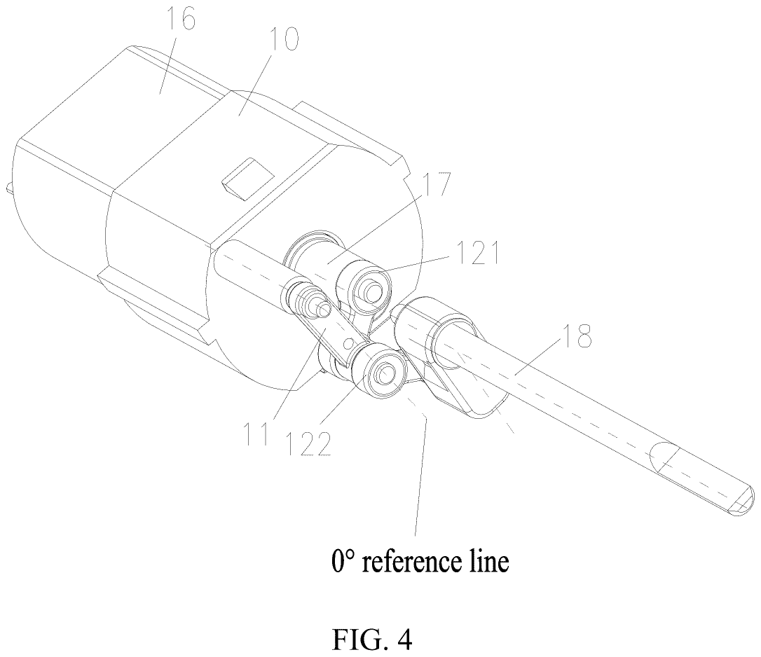

As shown in FIG. 4, when the eccentric wheel 17 further rotates anticlockwise to 180°, the swing rod 11 is driven by means of the first connecting rod 121 to rotate clockwise by 20°, and at this moment, the swing rod 11 rotates onto the 0° reference line again.

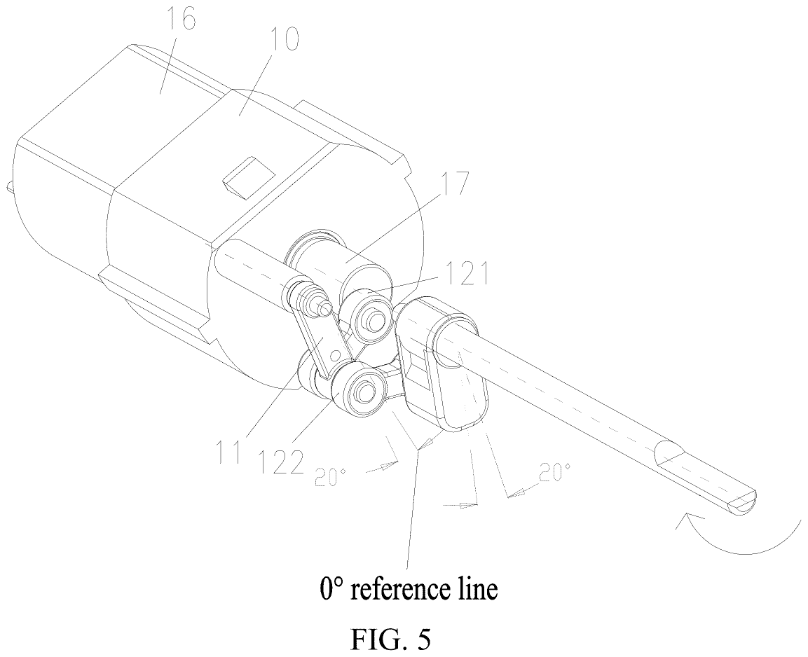

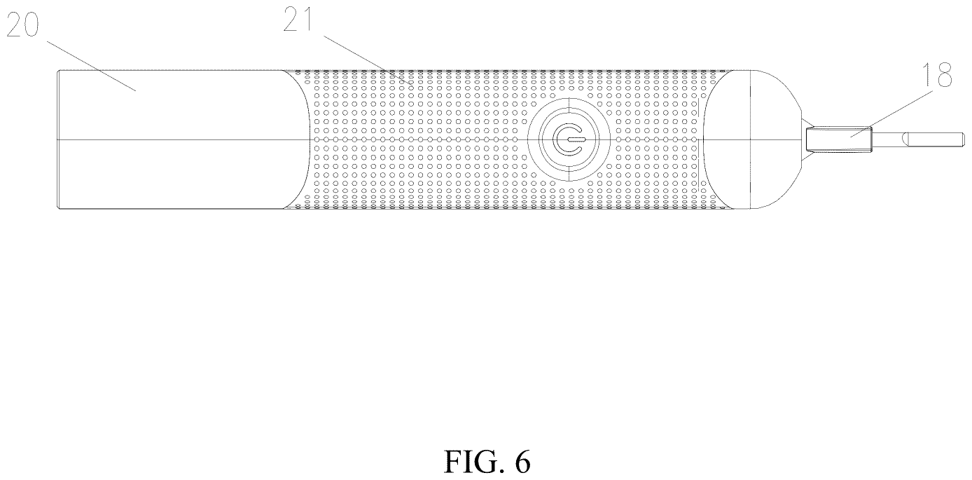

As shown in FIG. 5, when the eccentric wheel 17 further rotates anticlockwise to 270°, the swing rod 11 is driven by means of the first connecting rod 121 to further rotate clockwise by 20°. As shown in FIG. 6, when the eccentric wheel 17 rotates to 360°, the swing rod 11 is driven by means of the first connecting rod 121 to rotate anticlockwise by 20° to be located on the 0° reference line again. In this way, every time the eccentric wheel 17 rotates by a round, the swing rod 11 and the drive shaft 18 swing back and forth once.

Compared with a gear mechanism and a track type link mechanism, the rotating mechanism in this embodiment connects the wheel axle 170 of the eccentric wheel 17 and the drive shaft 18 by means of the two connecting rods and the swing rod 11, such that the drive shaft 18 swings more stably and smoothly, and power consumption and noise are reduced, thus prolonging the service life of the electric toothbrush using the rotating mechanism.

As shown in FIG. 1, in some embodiments, the rotating mechanism further includes an intermediate support 13 connected to the motor holder 10. The intermediate support 13 is used for mounting the drive shaft 18. A first positioning pillar 181 and a second positioning pillar 182 are arranged at an end, connected to the second connecting rod 122, of the drive shaft 18.

A positioning hole coaxial with the output shaft of the motor 16 is formed in intermediate support 13. The drive shaft 18 is located on a side, facing away from the motor holder 10, of the intermediate support 13. The first positioning pillar 181 of the drive shaft 18 is rotationally connected to the positioning hole in the intermediate support 13, and the second connecting rod 122 is rotationally connected to the second positioning pillar 182 of the drive shaft 18. When the swing rod 11 rotates, the drive shaft 18 is driven by means of the second connecting rod 122 to swing around an axis of the first positioning pillar 181 on the drive shaft 18. It is easily known that a receding space allowing the second positioning pillar 182 to rotate may be formed on the intermediate support 13.

As shown in FIG. 1, in some embodiments, the first connecting rod 121, the swing rod 11 and the second connecting rod 122 are all located between the intermediate support 13 and the motor holder 10 and sequentially arranged along an axis of the output shaft of the motor. The first connecting rod 121 and the second connecting rod 122 are located on two opposite sides of the swing rod 11. The first connecting rod 121 and the second connecting rod 122 are close to the swing rod 11, such that the rotating mechanism has a compact structure.

Further, in this embodiment, rotating shafts are arranged at the two ends of the swing rod 11 respectively, shaft holes are formed in two ends of each of the two connecting rods respectively, the two shaft holes in the first connecting rod 121 are correspondingly disposed around the wheel axle 170 of the eccentric wheel 17 and one rotating shaft on the swing rod 11, and the two shaft holes in the second connecting rod 122 are correspondingly disposed around the other rotating shaft on the swing rod 11 and the second positioning pillar 182 on the rotating shaft, such that the connection between the swing rod 11 and the two connecting rods is facilitated.

As shown in FIG. 1, in this embodiment, a connecting shaft 100 parallel to the axis of the output shaft of the motor 16 is arranged on the motor holder 10, and the connecting shaft 100 deviates from the output shaft of the motor 16. A positioning hole is formed in an end of the connecting shaft 100, and the rotating shaft at the first end of the swing rod 11 extends into the positioning hole and is connected to the positioning hole, and when the eccentric wheel 17 rotates, the swing rod 11 is driven by means of the first connecting rod 121 to swing around an axis of the connecting shaft 100. In this way, assembly of the swing rod 11 is facilitated.

As shown in FIG. 1, in some embodiments, the rotating mechanism further includes a top support 14 and a sealing sleeve 15, which are disposed around the drive shaft 18. The top support 14 is located on the side, facing away from the motor holder 10, of the intermediate support 13 and connected to the intermediate support 13, and the top support 14 is used for stabilizing the drive shaft 18.

In this embodiment, the top support 14 and the sealing sleeve 15 are disposed around the drive shaft 18, and the top support 14 is in clearance fit with the drive shaft 18, such that the drive shaft 18 may rotate without being affected by the top support 14. The sealing sleeve 15 is in interference fit with the drive shaft 18, such that a water flow is prevented from entering the electric toothbrush. Preferably, the sealing sleeve 15 is made from silicone.

To guarantee the strength and waterproofness of the drive shaft 18, in this embodiment, the drive shaft 18 is made from stainless steel, and the drive shaft 18 is sleeved with a rubber coating. The drive shaft 18 is protected by the rubber coating.

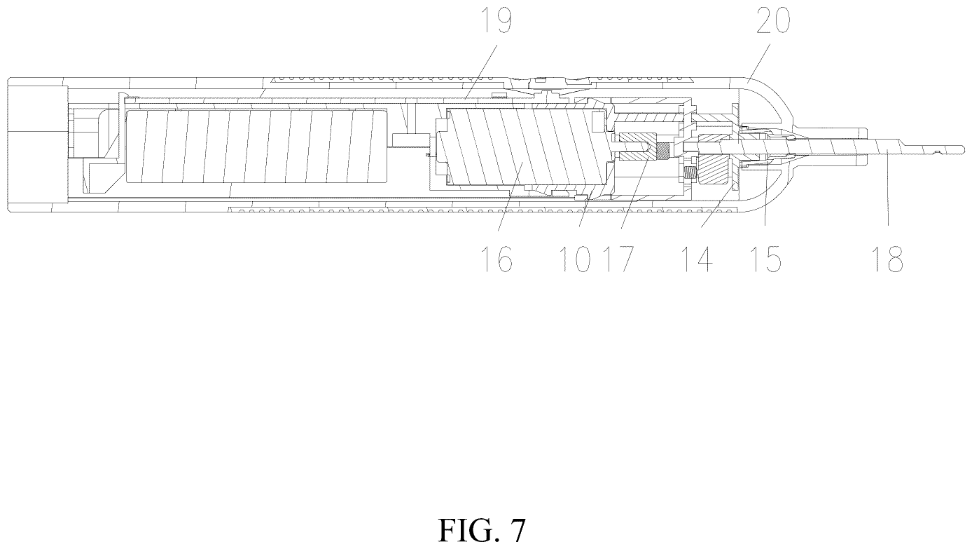

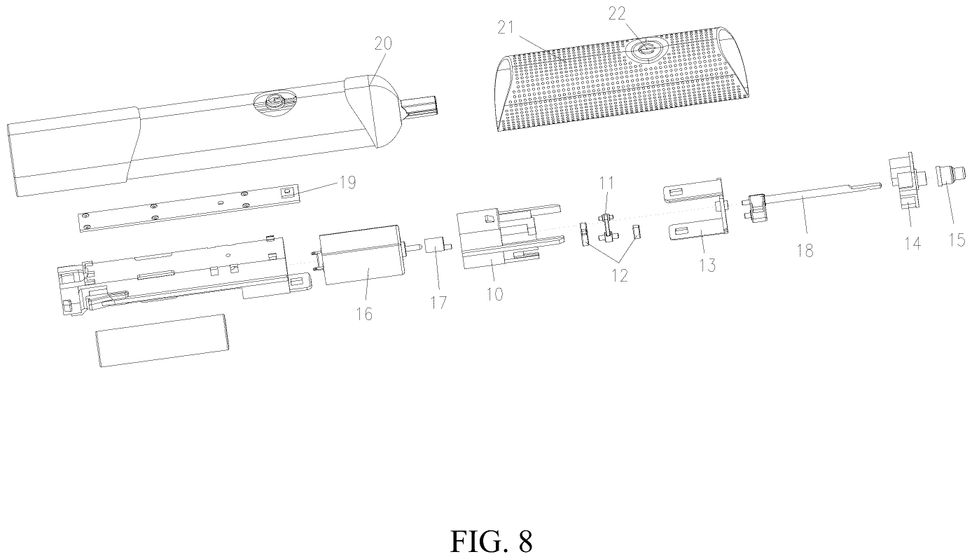

As shown in FIGS. 6-8, one embodiment of the present disclosure further provides an electric toothbrush. The electric toothbrush at least includes a control board 19, a housing 20, a rubber sleeve 21, and the rotating mechanism according to any one of the above embodiments.

The housing 20 wraps around the control board 19 and the rotating mechanism, the drive shaft 18 of the rotating mechanism extends out of the housing 20, and a free end of the drive shaft 18 is connected to a brush head. The control board 19 is connected to the motor 16, and a switch for controlling the motor 16 to start and stop is arranged on the control board 19.

The rubber sleeve 21 is disposed around the housing 20, a button 22 is arranged on the rubber sleeve 21 and corresponds to the switch on the control board 19, and the switch is controlled by means of the button 22.

The above embodiments are merely illustrative ones of the present disclosure and are not intended to limit the present disclosure, and the protection scope of the present disclosure is defined by the claims. Various modifications or equivalent substitutions of the present disclosure may be made by those skilled in the art based on the spirit and protection scope of the present disclosure, and all these modifications or equivalent substitutions should also be construed as falling within the protection scope of the present disclosure.

What is claimed is:

1. A rotating mechanism, applied to an electric toothbrush, the electric toothbrush comprising a motor, a drive shaft and an eccentric wheel arranged on an output shaft of the motor, and the drive shaft being connected to a brush head, wherein the rotating mechanism comprises:
a motor holder, used for mounting the motor;
a swing rod, having a first end rotationally connected to the motor holder; and
a connecting rod assembly, comprising a first connecting rod and a second connecting rod, the first connecting rod being rotationally connected to a wheel axle of the eccentric wheel and a second end of the swing rod, and the second connecting rod being rotationally connected to the drive shaft and the second end of the swing rod;
when the eccentric wheel rotates, the swing rod is driven by means of the first connecting rod to swing with respect to the motor holder within a preset angle range, and when the swing rod swings, the drive shaft is driven by means of the second connecting rod to swing synchronously.

2. The rotating mechanism according to claim 1, further comprising an intermediate support, wherein the intermediate support is connected to the motor holder, a first positioning pillar and a second positioning pillar are arranged on the drive shaft, the first positioning pillar is rotationally connected to the intermediate support, and the second positioning pillar is rotationally connected to the second connecting rod.

3. The rotating mechanism according to claim 2, wherein the first connecting rod, the swing rod and the second connecting rod are all located between the intermediate support and the motor holder and sequentially arranged along an axis of the output shaft of the motor.

4. The rotating mechanism according to claim 2, wherein rotating shafts are arranged at the two ends of the swing rod respectively, shaft holes are formed in two ends of each of the two connecting rods respectively, the shaft holes in first ends of the two connecting rods are correspondingly disposed around the wheel axle of the eccentric wheel and the drive shaft, and the shaft holes in second ends of the two connecting rods are respectively disposed around the rotating shafts on the swing rod.

5. The rotating mechanism according to claim 4, wherein a connecting shaft parallel to an axis of the output shaft of the motor is arranged on the motor holder, the connecting shaft deviates from the output shaft of the motor, a positioning hole is formed in an end of the connecting shaft, and the first end of the swing rod extends into the positioning hole and is in clearance fit with the positioning hole.

6. The rotating mechanism according to claim 2, further comprising a top support and a sealing sleeve which are disposed around the drive shaft, wherein the top support is connected to the intermediate support, the sealing sleeve is fixed to the top support, the top support is in clearance fit with the drive shaft, and the sealing sleeve is in interference fit with the drive shaft.

7. The rotating mechanism according to claim 6, wherein the drive shaft is sleeved with a rubber coating.

8. The rotating mechanism according to claim 7, wherein the drive shaft is made from stainless steel, and the sealing sleeve is made from silicone.

9. The rotating mechanism according to claim 1, wherein the present angle range is −20°˜20°.

10. An electric toothbrush, comprising the rotating mechanism according to claim 1.
